(19) United States
(12) Patent Application Publication
(10) Pub. No.: US 2012/0011218 A1
(43) Pub. Date: Jan. 12, 2012

(54) System for Information and Function Retrieval

(76) Inventor: Charles H. Isaacs, San Jose, CA (US)

(21) Appl. No.: 12/894,483

(22) Filed: Sep. 30, 2010

Related U.S. Application Data
(60) Provisional application No. 61/363,426, filed on Jul. 12, 2010.

(51) Int. Cl. G06F 15/16

(52) U.S. Cl. 709/217

(57) ABSTRACT

A system for retrieving information over a network includes a machine readable code implemented in a visible fashion on a product or product representation, and a set of machine instructions implemented as a software application resident on and executable from the digital medium of a mobile network appliance. A user operating the mobile network appliance connected to the network and aided by the set of machine instructions acquires the machine readable code associated with the product or representation thereof whereupon the machine readable code is interpreted by the application to identify and retrieve or otherwise acquire and display on the mobile appliance one or more interactive menu options relative to the product or product representation, the interactive menu options selectively evocable to cause navigation to and or connection with an information source on the network adapted to service inquiries and requests relative to the product.

### CROSS-REFERENCE TO RELATED DOCUMENTS

The present invention is a Non-Provisional application of U.S. Provisional application 61/363,426, filed on Jul. 12, 2010. The disclosure of priority application is incorporated herein at least by reference.

### BACKGROUND OF THE INVENTION

1. Field of the Invention

The present invention is in the field of ecommerce including retail transaction networks and pertains particularly to methods and apparatus for retrieving information and functional contact options relative to offered products and services in a manner that is more expedient.

2. Discussion of the State of the Art

In the art of ecommerce, businesses that sell products and services maintain or contract network-based communications services for interacting with potential customers having mobile network appliances like cellular telephones, personal digital assistants, and other network-capable hand-held devices. For the purposes of this specification a hand-held and network-capable appliance shall refer to any computerized appliance that can connect to a network such as the Internet network using an operating system (OS) and navigation application (browser) where content is retrieved and displayed on a touch screen or other relevant display wherein the user may interact with the content to achieve a goal such as conducting a transaction, disseminating information, or embarking in live interaction with a human or an automated system.

Often in ecommerce, a user operating a mobile appliance will connect to the Internet and navigate to a Website to learn more about a product or service that is being offered for sale through the Website. In this process the user is either responding to an advertisement, following up on previously digested information received from a third-party, or acting on behalf of a physical stimulus such as viewing or otherwise interacting with a product on a retail shelf in a retail outlet. Products are typically assigned product codes that are implemented in a bar code format that can be scanned into a barcode reader or application. The information included in a barcode format for a product is typically limited to static data such as price of the product and similar static data about the product such as inventory control numbers and manufacture data.

Therefore, what is clearly needed is a system for retrieving information including functional options based on code interpreted from a barcode or similar type of code associated with a product.

### SUMMARY OF THE INVENTION

A problem stated above is that while immediate accessibility to pertinent solution-oriented information is desirable for enterprises advertising products and services to potential customers, traditional means of making such information available to potential customers is often compromised in terms of expediency by requiring specific or traditional network-based processes to access the information such as using email, navigating to a contact page, or searching for the contact information using a search interface. Moreover, information currently associated with physical products is static information that can be lifted from packaging or from the bar code and then used to eventually make contact in order to request more information.

The inventors therefore considered functional components of client/server Internet information site and product information codes like bar codes including quick response (QR) codes looking for elements that could be seamlessly combined to provide immediate and unfettered access to current information and contact data relative to a product of interest at the time that the potential customer is interacting with the product or a representation thereof such as an advertisement and would be most likely to act to learn more or to enter into a transaction.

Success in advertising depends partly on the number of units and or service contracts having been sold in a relative period of time. Therefore, the more efficient the customer is in obtaining and disseminating information conducive to purchasing the product the more success is realized by the provider of the product or service.

The present inventor realized in an inventive moment that if, at the time of interaction with a product or service advertisement pertinent information including accurate and current contact information could be caused to appear in a familiar manner in the customer's network appliance display, much work related to navigating contact channels and information could be eliminated. The inventor therefore constructed a unique system for retrieving information that allowed users to scan or otherwise acquire product code relevant to products or their advertisements for the purpose of more efficient retrieval of additional information about the products or services and state-of-art functionality that aids the potential customer in purchasing the product or service.

Accordingly, in an embodiment of the present invention, a system is provided for retrieving information over a network. The system includes a machine readable code implemented in a visible fashion on a product or product representation and a set of machine instructions implemented as a software application resident on and executable from the digital medium of a mobile network appliance. A user operating the mobile network appliance connected to the network and aided by the set of machine instructions acquires the machine readable code associated with the product or representation thereof whereupon the machine readable code is interpreted by the application to identify and retrieve or otherwise acquire and display on the mobile appliance one or more interactive menu options relative to the product or product representation, the interactive menu options selectively evocable to cause navigation to and or connection with an information source on the network adapted to service inquiries and requests relative to the product.

In a preferred embodiment, the information source is an information portal or Website hosted on the network and the network is the Internet network. In one embodiment, the machine-readable code identifies menu options for interaction between the user and a product host or provider and includes a universal resource locator (URL) on the network for download and display of the options. In one embodiment, the mobile network appliance is one of a cellular telephone, a laptop computer, or a personal digital assistant.

In one embodiment of the present invention, the menu options are dynamically configured or are pre-configured and embedded in a toolbar extension that is downloaded and displayed in the user's browser application. In one embodiment, the machine-readable code is scanned into the mobile network appliance. In another embodiment, the machine-readable code is copied or retrieved from another mobile appliance. In still another embodiment, the machine-readable code is photographed and interpreted from the saved photo.

In one embodiment, the machine readable code is a quick response code containing at least a URL pointing to additional code defining button text and function calls. In one embodiment, the menu options are created using State Chart extensible Markup Language.

According to an aspect of the present invention, a method is provided for retrieving information over a network comprising the steps (a) providing with a product or a representation thereof, a machine readable code that identifies at least a network source of more information relative to the product, (b) with the aid of a software application resident on a mobile network appliance connected to the network, acquiring and interpreting the code of step (a), (c) in response to interpretation of the code at step (b), navigating or otherwise connecting to the information source identified in step (a) and, (d) accessing one or more interactive menu options allowing interaction between the operator of the mobile network appliance and one or more agents of the information source.

In a preferred aspect, the method is practiced using the mobile network appliance while connected to the Internet. On one aspect, in step (a), the machine-readable code is a quick response code. In one aspect, in step (a), the machine-readable code identifies at least a universal resource locator (URL) of the information source. In another aspect of the method, in step (b), the code is acquired by a scanning application running on the mobile network appliance. In still another aspect, in step (b), the code is acquired by a camera application running on the mobile appliance. In one aspect, in step (c), the information source is a Website.

In one aspect of the method, in step (d), the one or more menu options are embedded in a toolbar extension that is accessed by downloading the extension. In one aspect of the method, in step (d), the menu options are pre-configured for the product. In another aspect, in step (d), the menu options are dynamically generated for the product.

### BRIEF DESCRIPTION OF THE DRAWING FIGURES

FIG. 1 is an architectural view of a communications network supporting retrieval of code-activated information according to an embodiment of the present invention.

FIG. 2 is a process flow chart illustrating steps for processing a code to return interactive options according to an embodiment of the present invention.

FIG. 3 is a process flow chart illustrating steps for configuring interactive options for code access according to an embodiment of the present invention.

FIG. 4 is a screenshot of a mobile application displaying interactive options according to an embodiment of the present invention.

### DETAILED DESCRIPTION

The inventors provide a system and methods for enabling efficient retrieval of information and interactive menu options relative to a product or service or representation thereof through acquisition and leverage of code associated with a barcode or similar information code associated with the product. The methods and system of the present invention are described in enabling detail below using the following examples that may singularly or collectively describe one or more than one embodiment of the present invention.

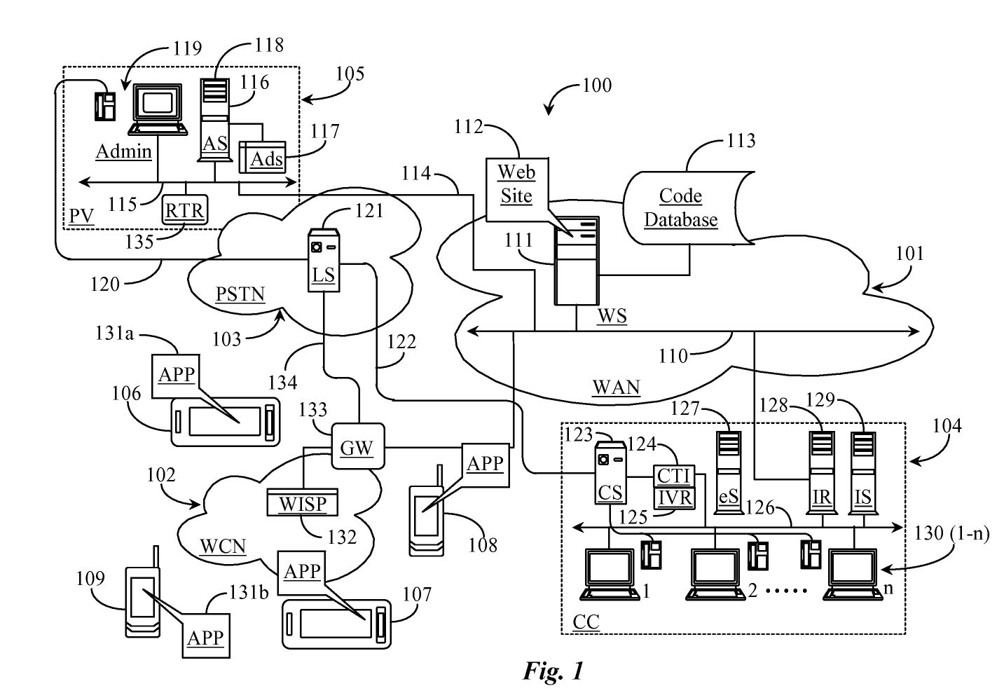

FIG. 1 is an architectural view of a communications network 100 supporting retrieval of code-activated information according to an embodiment of the present invention. Communications network 100 may be thought of as an ecommerce network that includes a wide-area-network (WAN) 101. WAN 101 may be a private or corporate WAN or a public WAN such as the well-known Internet network without departing from the spirit and scope of the present invention. The inventors prefer that WAN 101 is the Internet network because of the high public-accessibility characteristic of the Internet making it viable carrier network for ecommerce.

Communications network 100 includes a wireless carrier network 102. Wireless network 102 may be any wireless sub-network over which telephony including data network telephony and messaging services can be practiced from a suitable mobile computing appliance. Communications network 100 also includes the well-known public switched telephone service (PSTN) 103. PSTN 103 may instead be a private or corporate telephone network or wireless local loop without departing from the spirit and scope of the invention. The inventor prefers that wireless network 102 and PSTN 103 are publicly accessible networks and as sub-networks are connected to Internet network 101. Internet network 101 is also exemplified herein by a network backbone 110. Network backbone 110 represents all of the lines, equipment, and access points, including connected sub-networks, which make up the Internet network as a whole. Therefore, there are no geographic limitations to the practice of the present invention.

Communications network 100 includes a call center (CC) 104. CC 104 represents a contact center service provider that provides sales services and technical assistance to customers and potential customers or clients of a business entity such as a product vendor illustrated in this example as a product vendor 105. In this example CC 104 provides contact center services including, but not limited to, sales and technical service to customers and potential customers of product vendor 105. Product vendor 105 provides products that are available to the public such as products that may be available in retail locations and products that might be available for purchase online as well.

Product vendor 105 includes a local area network (LAN) 115 adapted as a sub-network of WAN 101. LAN 115 has connection to network backbone 110 by way of a network access line 114 and a data router 135. LAN 115 supports an advertisement server 116. Advertisement server 116 includes a digital medium (not illustrated) that contains the software and data required to enable server function as an advertisement server. Advertisement server 116 has connection to a data repository 117 adapted to store advertisements and relevant data for service or upload to CC 104 or some other third-party for service to clients of product vendor 105. LAN 115 also supports an administrative (Admin) station 119. Admin station 119 includes a LAN-connected computing appliance, and a standard telephone. An administrator operating from the computing appliance of Admin station 119 may pre-configure services that will be offered to clients through website 112 running on Web server 111.

CC 104 may be any state-of-art call in center that may have private agreements to service companies like product vendor 105. CC 104 has a central switch (telephony switching Facility) 123 provided therein and adapted to receive calls coming in from external networks and to function as a switch for forwarding calls onto the network. Central switch 123 may be a corporate, private, or public telephone switch, including a soft switch without departing from the spirit and scope of the present invention.

Central switch 123 is computer telephony integrated (CTI) with the aid of a CTI processor 124 connected to Central switch 123 via a CTI link. Interactive voice response (IVR) capability is provided to switch 123 via IVR component 125. Central switch 123 has connection to a local telephony switch 121 in public switched telephone network (PSTN) 103 via telephony communications trunk 122. LAN 126 in CC 104 supports agent stations 130 (1-n). Agent stations 130 (1-n) are logically illustrated herein as including a computing appliance connected to LAN 126 and a telephone. Agents operating at agent stations 130 (1-n) are trained to fulfill requests from customers and potential customers like clients of product vendor 105. LAN 126 also supports an email server/routing system 127 and an interaction server 129 for serving interaction requests to connected agents waiting to fulfill those requests.

Wireless carrier network 102 provides wireless connectivity to potential customers operating wireless appliances such as a smart phone 106, a smart phone 107, a cellular telephone 108, and a cellular telephone 109. Other wireless network-capable appliances might also be included as devices operated by potential clients of product vendor 105. It is noted herein that a network-capable appliance shall mean any appliance that can navigate the network and also be used as a communications device. Typically such devices include network navigation software, an operating system, a display screen and at least one means of data input other than voice. Other types of devices that could be classified as a network-capable communications appliance might include Laptop computers and personal digital assistant (PDA) devices.

In one embodiment of the present invention, web server 111 has an external high-speed data connection to a code database 113 that includes product codes uploaded thereto by companies participating in the practice of the present invention, such as product vendor 105. Code database 113 is a searchable database and may be accessed through Website 112. Potential customers may scan or otherwise acquire a product bar code and or a quick-response code or some other similar type of machine-readable code using code-acquisition and interpretive applications 131a installed on smart phones 106 and 107 or application 131b installed on cellular telephones 108 and 109. The application differences giving rise to the use of separate element numbers may be limited to device type differences. Generally speaking application 131 is a downloaded mobile application that enables a customer or potential customer to scan or otherwise acquire a product code such as a barcode or “quick-response code associated with any product type that the operator might be interacting with.

For the purposes of definition, a quick-response code is a two matrix barcode that can be acquired from the point of a mobile computing appliance using an application similar to application 131 (a,b) installed on the illustrated mobile communications appliances 106-109. Hard link data such as a universal resource indicator and contact information may be embedded in a quick-response quick-response code and then interpreted on the hand-held mobile communications appliance. The code may be acquired using a scanning application or by taking a picture of the code and using the application to interpret the code disseminating the contact information.

In accordance with a preferred embodiment of the present invention, product vendor 105 has products or at least advertisements that include visible quick-response code or similar bar code indicia such that when the code is scanned into or otherwise acquired on appliances 106-109, the operators may then have immediate access to contact information or Website navigation information. In one embodiment of the present invention, scanning in or otherwise acquiring a machine readable code causes a mobile appliance such as one of appliances 106-109 to automatically navigate to web site 112 where the interpreted code is leveraged to search for matching code in code database 113. Finding a match in database 113 immediately causes a dynamic display in the form of a graphics user interface (GUI) to appear on the display screen of the submitting appliance wherein that generated interface includes current interactive contact menu options and possibly availability states or indications of availability for each listed option. In addition search options such as knowledge base search options, social network search options, and the like might also be automatically generated and displayed in the interface.

In practice of the present invention, a product vendor may configure a product code to include a quick-response code or similar two-matrix barcode that includes a URL to Website 112. In this case Website 112 may be a member site with many product vendors signed on to a service that enable them to pre-configure a presentable GUI with contact and interaction options or to dynamically generate such an interactive menu upon detection of an event requiring such dynamic generation and presentation. For example, if a potential customer such as one operating appliance 106 aided by application 131a has scanned in or otherwise acquired a quick-response code associated with an advertisement painted on a billboard, the application on the appliance will interpret the code and perform the task of connecting to a Website such as Website 112 hosted on WS 111 for the purpose of checking the code against those in a database such as database 113.

The process of matching the code enables a third-party service such as call center 104 to perform the task of dynamic generation and presentation of interactive options that provide the potential customer with interactive and selectable menu options to further the process of interaction including the actions of purchasing the product, getting more information about the product, comparing the prices of the product with similar products, searching forums, social interaction sites or knowledge bases for more information about the product and similar interactive menu options. In one embodiment the scanned quick-response code may cause immediate navigation to a product vendor Website where stock or pre-configured interactive menu options are automatically displayed on the appliance screen of the connecting appliance, such as in a toolbar in the browser application, or in a special section of the application used to acquire the code from the advertisement or product. Various modalities are possible depending upon the situation, how the code is acquired, the environment relative to code acquisition and so on.

In one embodiment, an interactive option for resuming a Web-based transaction is one of the possible interactive menu options that can be included in the interpretation of the product code and dynamic menu generation. In such a case the potential customer might begin a transaction process and then suspend the process in order to resume the process again at a later or more convenient time. In one embodiment the interactive options are presented in an interface that is pre-installed on the potential customer's appliance where the scanned code is interpreted and the application retrieves the appropriate interactive menu options for fulfilling requests associated with that particular object or product.

In one embodiment the fulfillment criteria is related to the object in a tangible way that does not necessarily involve immediate connection to interactive resources such as a potential customer taking a picture of a barcode associated with a picture advertisement on window advertisement or similar physically painted advertisement on a billboard, vehicle, or building face. For example, a user may be visiting a town and may take a picture of a clothing advertisement painted on the side of a bus where the application on the user's device interprets the code and, as a result, navigates to a web site and returns, for example, directions to a local store in that town where the clothing may be purchased. In the same scenario, the returned interactive options might well include options for purchasing the advertised clothing online.

In one embodiment a barcode including quick-response code or similar code maybe associated with an advertised service instead of a physical product. For example, a user might open a page in a local newspaper and may scan in a barcode associated with a named fitness facility. The scanned code may be interpreted on the hand-held appliance with the aid of the provided application and may immediately cause navigation to a Website hosted by the service, where the user may sign up and become a member of the fitness service. A plurality of relevant interactive options may also be included such as talk to a trainer, search locations, and other like interactive options.

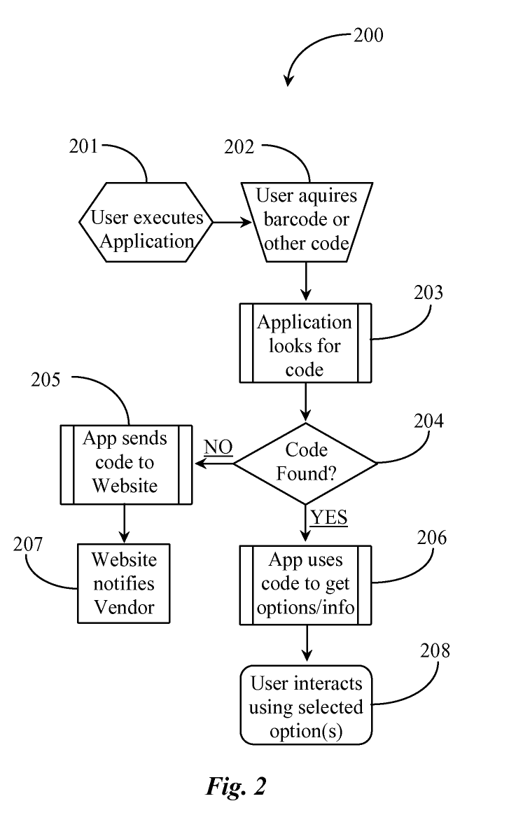

FIG. 2 illustrates a process flow chart 200 with steps for processing a code to return interactive options according to an embodiment of the present invention. At step 201 a user executes an application on a hand-held network-capable appliance. In one embodiment the application, once executed establishes a connection to an Internet service provider or Website such that the hand-held appliance is connected to the network. At step 202 the user scans in or otherwise acquires, such as by photographing, a barcode including a quick response code or similar code.

At step 203 the application running on the hand-held appliance looks for a match to the acquired code in a code database provided for the purpose that is accessible through the Website that the application is connected to. In another embodiment the code is first scanned or otherwise acquired and the application interprets a URL or Uniform Resource Identifier (URI) from the code and then establishes an online connection to a Website. At step 204 the system determines if the code was found in the database.

If the system determines that the code was not found, the application may send the scanned or photographed code to the web site at step 205. The functionality of the web site may include interpreting the code to determine at least the vendor responsible for the product identified in the barcode. With this functionality enabled, the web site may perform a look-up to find the appropriate vendor and, if found, may notify the appropriate vendor at step 207 that the code was acquired and checked against the database with no returnable result. The vendor may then be solicited by the web service to enable interactive menu options to be configured for and presented to those potential customers that are already signed up for the service, have the application, and are attempting to interact with that vendor's products, services or advertisements related to them.

Referring now back to step 204, if the code is found in the web database, then the application uses the code to get interactive options for transacting, obtaining more information, live assistance, and like options. In one embodiment the options are displayed in the GUI on the appliance used to connect to the web service. In another embodiment the options present in a tool bar in the user's browser. In still other embodiments, the interactive options are displayed in a pop-up window or some other graphics display as a list of selectable options. At step 208 the potential customer or user may interact with any of the options that were selected.

One with skill in the art of web services will understand that vendor participation in a member web site and service is not a prerequisite for practicing the present invention. For example, a product vendor may provide their own personalized services for their customers and potential customers without engaging with a third-party service provider.

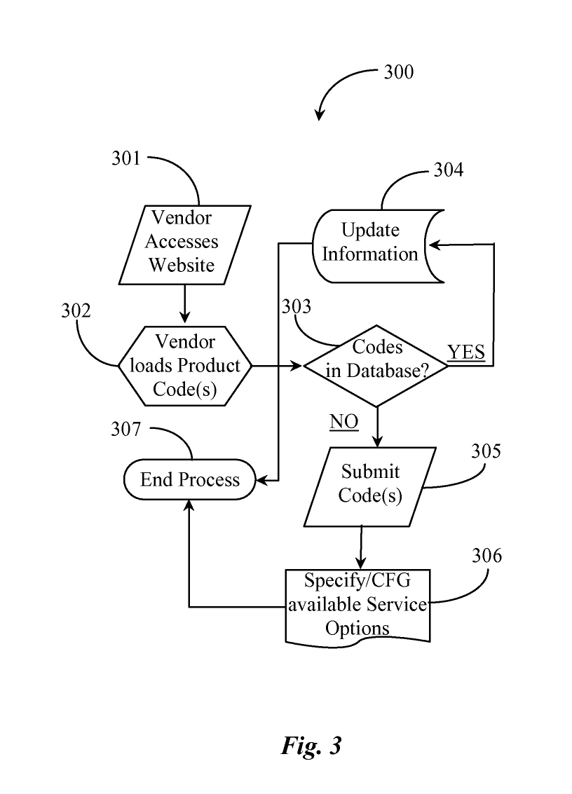

FIG. 3 is a process flow chart 300 illustrating steps for configuring interactive options for code access according to an embodiment of the present invention. At step 301 a vendor accesses a member web site adapted to service the potential customers and established customers of that vendor. At step 302 the product vendor loads the appropriate product codes and functionality for the resulting menu options that will be presented to customers and potential customers of that product vendor. The product vendor may perform step 302 for one or a few or a large line of products and services. The product vendor may provide code that has syntax that enables the vendor to generate menu options and write the call functions behind the options. For example, the code can be a comma-separated list consisting of “button text”, “function calls”, “optional parameters”, “GUI type”, and “optional context.”

Button text is defined as hypertext associated with an interactive button such as “chat now” text applied to the button. A function call is defined as a function running on the handheld “interpreter” application such as applications 131 that encompasses some interactive input. Functions that may be provided as interactive solutions might include a search function for searching knowledge bases, a search and post function for social interaction pages, a short message service (SMS), a text chat interface, an email interface, a product locator interface, a post/search function for discussion forums, a function for accepting a served advertisement, a function for performing a transaction, a function for retrieving special offers (advertising), a function for playing instructional slides or videos, and a function for resuming a transaction already started.

Referring now back to flow chart 300, at step 303 the web service determines if the product codes the vendor is uploading are already in the product code database. If the code is in the database, the web service may ask the product vendor if they wish to update the information at step 304 by adding or changing functions or test definitions, etc. The process may then end at step 307.

If the product code being uploaded by the product vendor is not already in the code database at step 303, the web service may ask the product vendor to submit the code or codes at step 305. At step 306 the web service may provide interfacing ability for the product vendor to specify and configure available service options. In one embodiment where a resume transaction option is available, the customer or potential customer might be at an automated transaction machine (ATM) for example. If the user does not wish to complete a transaction, they may scan the transaction or product code on the ATM screen and take the code with them. At a later time they can invoke the hand-held application, select the entry for their transaction, and select “Resume Transaction”. At such a point in processing, they could be routed to a third-party contact center for service. The context surrounding the transaction can also be passed to the center agent servicing the transaction via interactive voice response (IVR), dual tone multi-frequency, or via web service. The customer might instead just complete the transaction via a web service. In one embodiment, a security code may also be set and passed along with the context in an encrypted format.

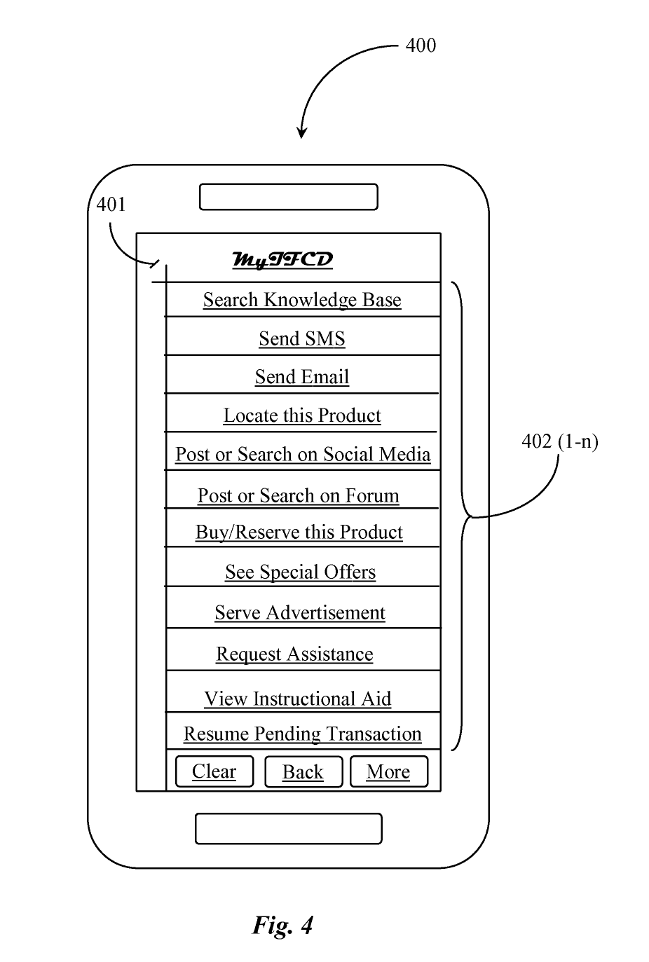

FIG. 4 is a representation 401 of an interactive display of a mobile application displaying interactive options according to an embodiment of the present invention. A hand-held appliance 400 has a touch screen display 401 labeled My iCFD. A plurality of interactive menu options 402 (1-n) is listed in the display. In this embodiment the menu options are assembled and served to the application on the hand-held after the code is interpreted and used to retrieve the options.

Reading from top to bottom in screenshot 401, the interactive and selectable options are search knowledge base, send SMS, send email, locate this product, post or search on social media, post or search on discussion forum, buy or reserve the opportunity to buy this product, see special offers, serve advertisement, request live or automated assistance, view instructional aid, and resume pending transaction. At the bottom of the screenshot, the interactive buttons clear, back, and more are provided for navigation. In other embodiments of the present invention, the interface may be different and the options might also be presented differently without departing from the spirit ands scope of the present invention. For example, in one aspect and embodiment of the invention, in response to acquisition of a bar code, a quick response code, or any other specific indication identifying a product, communication options may be initiated through which the user may, as described above, accomplish a variety of goals respective to the product identified by the code or specific indicator, and, through the linking to social network sites, the user may keep contacts and associates informed about the results of his or her activities or intention regarding the product. For example “This is really cool”, “I bought it”, “You should get one of these”, and so on.

The code executing on the handheld application can also be decision-tree like. Or, it can be a representation of SCXML that is generated from another application such as a user-friendly coding application. Such an application could generate SCXML that is then converted to a scan-able code and moved to the handheld app and interpreted. Each code saved on the handheld could be represented in the application menu, and when the user selects one of the saved codes, it could check with a server to update the menus and information being interpreted on the handheld. There are many possibilities.

Drawings and description in the several embodiments described above focus on activation of functionality in the invention by scanning a bar code, a quick response code, or some other form of a code. The invention in some embodiments may be somewhat broader. A bar code or quick response code associates the product upon which it is affixed, or to which it is uniquely associated, to a cache of information that uniquely specifies that product. This may be done in some embodiments in any way that is specific and unique to a product. One might, for example, scan a written description of the product, and the scanner might parse the text for sufficient information to associate with the same cache of information reached by scanning a bar code or a quick response code. One might also accomplish the same functionality by imaging techniques. A digital picture of a product may in some cases be of sufficient detail to be associated with stored images to uniquely identify that produce, and access the same cache as accessed in the case of bar codes or quick response codes. The use of bar codes and quick response codes is therefore not a limitation, but a preference, in that these codes may be used to accomplish the needed specificity in activation. Images and text may not be as reliable, but may work quite well under some circumstances.

It will be apparent to one with skill in the art that the information and option retrieval system of the invention may be provided using some or all of the mentioned features and components without departing from the spirit and scope of the present invention. It will also be apparent to the skilled artisan that the embodiments described above are specific examples of a single broader invention, which may have greater scope than any of the singular descriptions taught. There may be many alterations made in the descriptions without departing from the spirit and scope of the present invention.

What is claimed is:

1. A system for retrieving information over a network comprising:
a machine readable code implemented in a visible fashion on a product or product representation; and
a set of machine instructions implemented as a software application resident on and executable from the digital medium of a mobile network appliance;
wherein a user, operating the mobile network appliance connected to the network and aided by the set of machine instructions, acquires the machine readable code associated with the product or representation thereof, whereupon the machine readable code is interpreted by the application to identify and retrieve or otherwise acquire and display on the mobile appliance one or more interactive menu options relative to the product or product representation, the interactive menu options selectively evocable to cause navigation to and or connection with an information source on the network adapted to service inquiries and requests relative to the product.

2. The system of claim 1, wherein the information source is an information portal or Website hosted on the network and wherein the network is the Internet network.

3. The system of claim 1, wherein the machine readable code identifies menu options for interaction between the user and a product host or provider, and includes a universal resource locator (URL) on the network for download and display of the options.

4. The system of claim 1, wherein the mobile network appliance is one of a cellular telephone, a laptop computer, or a personal digital assistant.

5. The system of claim 3, wherein the menu options are dynamically configured or are pre-configured and embedded in a toolbar extension that is downloaded and displayed in the user's browser application.

6. The system of claim 1, wherein the machine-readable code is scanned into the mobile network appliance.

7. The system of claim 1, wherein the machine-readable code is copied or retrieved from another mobile appliance.

8. The system of claim 1, wherein the machine-readable code is photographed and interpreted from the saved photo.

9. The system of claim 1, wherein the machine readable code is a quick response code containing at least a URL pointing to additional code defining button text and function calls.

10. The system of claim 1, wherein the menu options are created using State Chart extensible Markup Language (SCXML).

11. A method for retrieving information over a network comprising the steps:
(a) providing with a product or a representation thereof, a machine-readable code that identifies at least a network source of more information relative to the product;
(b) with the aid of a software application resident on a mobile network appliance connected to the network, acquiring and interpreting the code of step (a);
(c) in response to interpretation of the code at step (b), navigating or otherwise connecting to the information source identified in step (a) and;
(d) accessing one or more interactive menu options allowing interaction between the operator of the mobile network appliance and one or more agents of the information source.

12. The method of claim 11, practiced using the mobile network appliance while connected to the Internet.

13. The method of claim 11, wherein in step (a), the machine-readable code is a quick response code.

14. The method of claim 11, wherein in step (a), the machine-readable code identifies at least a universal resource locator (URL) of the information source.

15. The method of claim 11, wherein in step (b), the code is acquired by a scanning application running on the mobile network appliance.

16. The method of claim 11, wherein in step (b), the code is acquired by a camera application running on the mobile appliance.

17. The method of claim 11, wherein in step (c), the information source is a Website.

18. The method of claim 11, wherein in step (d), the one or more menu options are embedded in a toolbar extension that is accessed by downloading the extension.

19. The method of claim 11, wherein in step (d), the menu options are pre-configured for the product.

20. The method of claim 11, wherein in step (d), the menu options are dynamically generated for the product.
